(19) United States
(12) Patent Application Publication
(10) Pub. No.: US 2020/0269711 A1
(43) Pub. Date: Aug. 27, 2020

(54) System, Method, and Apparatus for Powering Vehicles

(71) Applicant: Edward A. VanDuyne, Riverview, FL (US)

(72) Inventor: Edward A. VanDuyne, Riverview, FL (US)

(21) Appl. No.: 16/286,678

(22) Filed: Feb. 27, 2019

(51) Int. Cl. B60L 53/12; B60L 53/66; B60L 9/00

(52) U.S. Cl. CPC B60L 53/12; B60L 9/00; B60L 53/665

(57) ABSTRACT

A method and apparatus of powering vehicles includes delivering a voltage across two road-based conductors and receiving one pole of the voltage by a first conductive surface of a first tire of the vehicle. The first conductive surface is in electrical contact with a first road-based conductor of the two road-based conductors. A second pole of the voltage is received by a second conductive surface of a second tire of the vehicle. The second conductive surface is in electrical contact with a second road-based conductor of the two road-based conductors. The voltage conducts from the first conductive surface and the second conductive surface into a charge circuit of the vehicle, thereby providing power to the vehicle for charging and/or for motivating the vehicle.

### FIELD

This invention relates to the field of power and more particularly to a system for providing power to vehicles.

### BACKGROUND

Many vehicles are transforming from being drive by fossil fuel to being driven by electricity. With advances in electric motor technology, battery technology, and other energy-saving vehicle subsystems, partial or completely electricity-driven vehicles are becoming more prevalent on our roads.

There are two major classifications of such vehicles: electrically powered vehicles and hybrid vehicles, the later retaining some form of fossil-fuel engine to provide power, either directly or through a generator, when the vehicle's batteries are depleted.

For all types of electric vehicles, the batteries have a limited range, much like a tank of fuel (e.g. gasoline) for vehicles powered by fossil fuel. This range is typically between 200 and 400 miles, limiting the distance that electric vehicles are able to travel before recharging to a similar distance to vehicles that are powered by fossil fuel having a full tank of fuel. One major difference between electric vehicles and vehicles powered by fossil fuel is the time it takes to recharge. To restore a fuel tank of a vehicle powered by fossil fuel (e.g. refill) takes only a few minutes, while to recharge the batteries of an electric vehicle requires a much longer time period. For example, one major manufacturer of electric vehicles indicates that it takes 20 minutes to charge to 50%, 40 minutes to charge to 80%, and 75 minutes to 100%. This is fine when the electric vehicle is parked at home or your office has a charge station, but this extended amount of time makes it difficult to drive an electric vehicle for long distances. For example, to drive from Miami to Los Angeles requires driving around 2700 miles. If your electric vehicle is 300 miles (one major manufacturer advertises 335 miles), this drive will require nine (9) stops to completely recharge the batteries. Therefore, assuming no traffic and a sustain speed of 60 miles per hour, a fossil-fuel driven vehicle having the same range would take 45 hours of driving, plus nine stops for fuels at roughly 10 minutes per stop, for a total of 46.5 hours. For the same trip, an electric vehicle having the same range would take 45 hours of driving, plus nine stops for recharging at roughly 75 minutes per stop (approximately 11 hours), for a total of 56 hours. Therefore, assuming a few of the stops for recharging also include breaks (e.g. sleeping, dinning), it will take somewhere between 5 and 10 hours longer to drive an electric vehicle across the nation as compared to a fossil-fuel driven vehicle.

What is needed is a system that will provide power to a vehicle while the vehicle is moving.

### SUMMARY

In one embodiment, a system for powering vehicles is disclosed including a powered roadway that has of a plurality of pairs of road-based conductors. Each pair of road-based conductors is parallel and a voltage is delivered across each of the pair of road-based conductors. A first tire of the vehicle has a first conductive surface and a second tire of the vehicle has a second conductive surface. The first conductive surface is in contact with a first road-based conductor of a pair of road-based conductors and the second conductive surface is in contact with a second road-based conductor of that pair of road-based conductors, thereby the voltage across that pair of road-based conductors is conducted into the vehicle through the first conductive surface and the second conductive surface. A vehicle power system receives the voltage from the first conductive surface and the second conductive surface and provides power to the vehicle.

In another embodiment, a method of powering vehicles is disclosed including delivering a voltage across two road-based conductors and receiving one pole of the voltage by a first conductive surface of a first tire of the vehicle. The first conductive surface is in electrical contact with a first road-based conductor of the two road-based conductors. A second pole of the voltage is received by a second conductive surface of a second tire of the vehicle. The second conductive surface is in electrical contact with a second road-based conductor of the two road-based conductors. The voltage conducts from the first conductive surface and the second conductive surface into a charge circuit of the vehicle, thereby providing power to the vehicle for charging and/or for motivating the vehicle.

In another embodiment, a system for powering vehicles is disclosed including a powered roadway having of a pair of road-based conductors that are parallel, a source of electricity and a controller. The controller selectively connects the source of the electricity to the pair of road-based conductors. A first tire of the vehicle has a first conductive surface and a second tire of the vehicle has a second conductive surface. The first conductive surface is in electrical contact with a first road-based conductor of the pair of road-based conductors and the second conductive surface is in electrical contact with a second road-based conductor of the pair of road-based conductors, thereby the voltage across the one pair of road-based conductors is conducted into the vehicle through the first conductive surface of the first tire and the second conductive surface of the second tire. A vehicle power system is electrically interfaced to the first conductive surface and to the second conductive surface. A vehicle detection sensor is operatively interfaced to the controller such that upon detection of the vehicle by the vehicle detection sensor, the controller connects the source of the electricity to the pair of road-based conductors, thereby providing the electricity to the vehicle and when the vehicle detection sensor signals an absence of the vehicle, the controller disconnects the source of the electricity from the pair of road-based conductors.

### BRIEF DESCRIPTION OF THE DRAWINGS

The invention can be best understood by those having ordinary skill in the art by reference to the following detailed description when considered in conjunction with the accompanying drawings in which:

FIGS. 1 and 2 illustrate a tire of a system for powering vehicles.

FIG. 3 illustrates the tire and hub/axle of the system for powering vehicles.

FIG. 4 illustrates a plan view of a roadway of the system for powering vehicles.

FIG. 5 illustrates a first side view of a roadway of the system for powering vehicles.

FIG. 6 illustrates an opposite side view of a roadway of the system for powering vehicles.

FIG. 7 illustrates a schematic view of a roadway of the system for powering vehicles.

FIG. 8 illustrates a schematic view of the system for powering vehicles.

FIG. 9 illustrates an alternate schematic view of the system for powering vehicles.

FIG. 10 illustrates a schematic view of a processor based circuit 60A

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

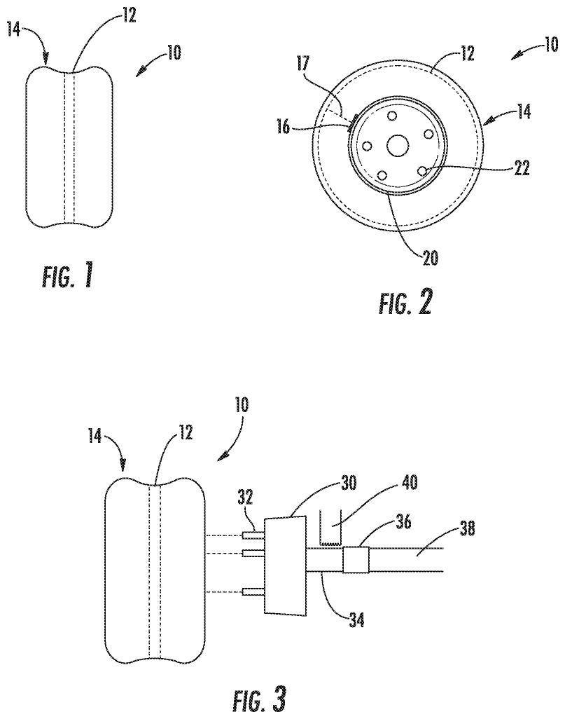

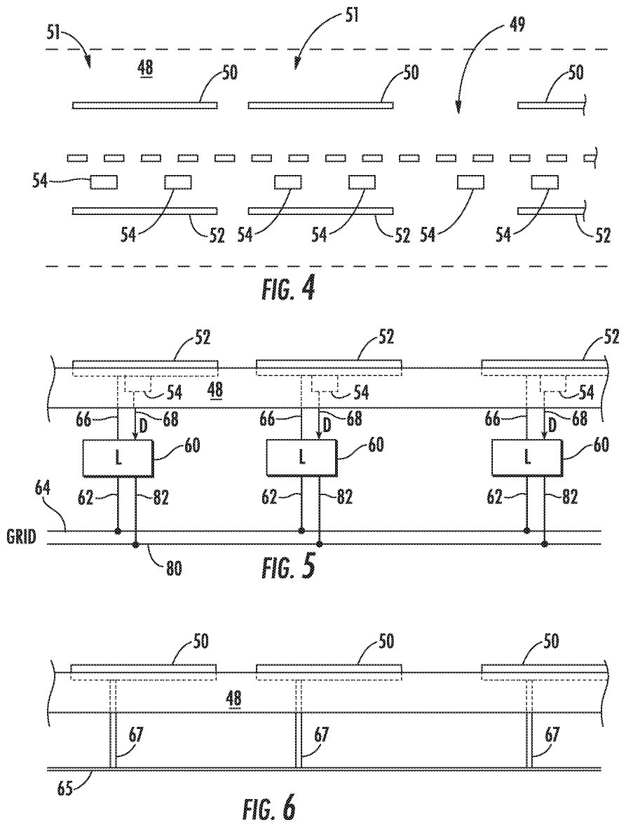

Referring to FIGS. 1 and 2, a tire 10 of a system for powering vehicles is shown. In FIG. 1, a front view of the tire 10 is shown having a tread 14, typically made from a formulation of flexible material such as rubber, as known in the industry. The tire 10 of a system for powering vehicles has a conductive surface 12 for conducting with the road-based conductors 50/52 (see FIGS. 4-8). Power from the conductive surface 12 is transferred to along an internal conductor 17 to a pad 16 on the bead of the tire 10 where the pad 16 contacts the wheel 20. The wheel 20, being made of a conductive metal, conducts electrical current from the conductive surface 12, through the internal conductor 17, through the pad 16 and to the brake hub 30 (see FIG. 3). The wheel 20 is held to the brake hub 30 by a plurality of lugs 32 fastened with lug nuts 22, thereby completing the circuit from the conductive surface 12 to the brake hub 30.

In some embodiments, the conductive surface 12 is recessed on the tire 10, thereby limiting contact between the conductive surface and everyday road surfaces to provide proper tire-road contact for traction, steering, etc.

In some embodiments, the conductive surface 12 is a band of metal fabricated into the tire 10, for example, a band of steel or copper.

In some embodiments, the conductive surface 12 is implemented by using a conductive material in the construction of the tire 10 (e.g. a conductive rubber) and, therefore, the entire tire 10 is conductive, not just a strip around the circumference. In this embodiment, there is no need for the internal conductor 17 and pad 16, as the entire tire 10 will conduct to the wheel 20.

Referring to FIG. 3, the tire 10 and hub/axle of the system for powering vehicles is shown. In this view, the tire 10 is mounted to the lugs 32 of the brake hub 30, making a completed circuit between the conductive surface 12 and the brake hub 30. In the embodiment shown, the brake hub 30 is interfaced to a first section 34 of an axle, the first section 34 of the axle is electrically insulated from the second section 38 of the axle by an insulator 36 so as to not short circuit the power provided by the road-based conductors 50/52. To accept power from the tire 10 (and the road-based conductors 50/52), a pickup 40 conducts electricity from the first section 34 of the axle and, hence from one of the road-based conductors 50/52 (a similar pickup will interface to the second section 38 to conduct electricity from another of the road-based conductors 50/52).

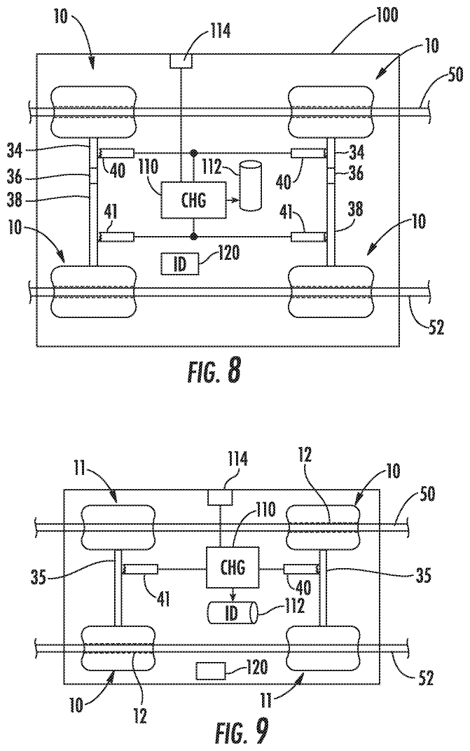

Referring to FIGS. 4, 5, and 6, views of a powered roadway 48 of the system for powering vehicles are shown. In FIG. 6, a view from the sky is shown. The powered roadway 48 has a plurality of road-based conductors 50/52, typically being substantially parallel to each other. Each of the road-based conductors 50/52 are powered when a vehicle 100 (see FIGS. 8 and 9) is detected by a vehicle detection sensor 54. In some embodiments, the vehicle detection sensor 54 senses the weight (mass) of the vehicle 100 (e.g. pressure on the road-based conductors 50/52), in other embodiments, the vehicle detection sensor 54 senses the electromagnetic being of the vehicle 100 or radio frequency resonance of metals from which the vehicle 100 is made. In some embodiments, the vehicle detection sensor 54 senses a radio frequency emitted by a radio frequency transmitter in the vehicle 100, in some embodiments, the vehicle detection sensor 54 senses a visual indication of the vehicle 100 such as from a camera, etc. Any form of vehicle detection sensor 54 is anticipated and included here within.

Note that the plurality of road-based conductors 50/52 are in multiple sections 51 with breaks between each section 51. By arranging each section 51 with a specific length or plurality of road-based conductors 50/52, it is anticipated that only a single vehicle 100 will be on any given section 51 at one time, thereby requiring only enough electric power at the plurality of road-based conductors 50/52 for a single vehicle 100. In alternate embodiments in which the section is much longer, it would be possible for several vehicles 100 to be on the same section 51 of road-based conductors 50/52, thereby requiring increased electrical power for that section 51. Further, in such alternate embodiments, once a vehicle 100 is detected, the entire section 51 receives electrical power, thereby increasing the possibility of a short between the road-based conductors 50/52 or electrical shock to a pedestrian. Being so, it is preferred that each section 51 of road-based conductors 50/52 be of limited length, for example, a length of an average sedan.

In some embodiments, multiple far road-based conductors 50 are provided to accommodate different wheelbases. In some embodiments, the road-based conductors 50/52 are bristles that are spring loaded so that the proper set of bristles extend upwardly to contact the conductive surfaces 12 of the tires 10 based upon the wheelbase of the vehicle 100 that is detected.

As it is anticipated that the road-based conductors 50/52 are raised above the powered roadway 48, it is anticipated that, once the vehicle 100 is situated on the road-based conductors 50/52 and the conductive surface 12 of the tires 10 of the vehicle 100 are in contact with respective road-based conductors 50/52, there will be a certain amount of resistance to lane changes. Therefore, as shown in FIG. 4, there will be exit areas 49 in which the gap between sections 51 of road-based conductors 50/52 is sufficient for the vehicle 100 to steer out of the lane. In such, it is anticipated that in some embodiments, the powered roadway 48 exist within a dedicated lane with limited entry and exit points, similar to those dedicated to high-occupancy vehicles (HOV lanes).

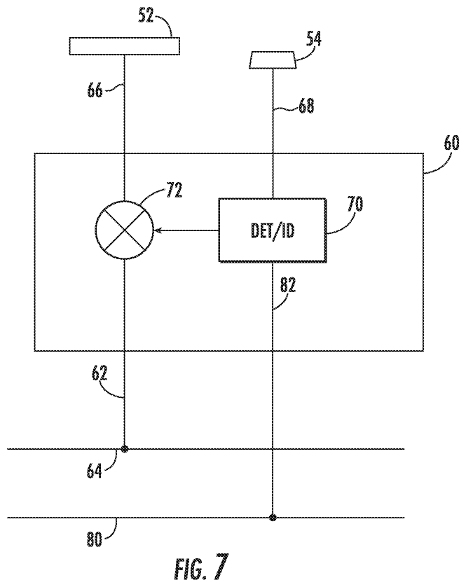

In FIG. 5, a side view of the powered roadway 48 is shown. In this, the near road-based conductor 52 is shown slightly raised above the powered roadway 48. The near road-based conductor 52 selectively receives a first pole of power through conductors 66 that connect the near road-based conductor 52 to a power switching device 72 (see FIG. 7) such as a relay or solid-state switch within a logic or processor-based circuit 60. Power for the powered roadway 48 is provided from a power grid 64 (source of electricity) that is connected to the other side of the power switching device 72. The power switching device 72 is controlled by switch control logic 70 (see FIG. 7). The switch control logic 70 reads the vehicle detection sensor 54 to determine if a vehicle 100 is present above the associated section 51 of road-based conductors 50/52. If the switch control logic 70 determines a vehicle 100 is present, the switch control logic 70 enables the power switching device 72 so that electrical power is provided to the near road-based conductor 52. In some embodiments, the switch control logic 70 includes a current limiting feature that prevents excess current flow through the road-based conductors 50/52 should a short circuit occur (e.g. a short from a snow plow blade).

Power is provided to the power switching device 72 by another conductor 62 that connects the power switching device 72 to the power grid 64. Note that, in some embodiments, the voltage potential delivered to the near road-based conductor 52 is set to a voltage deemed save for most form of life, for example, 48 volts, though there is no limitation on any particular voltage, either direct current or alternating current. Note also that it is fully anticipated that the power grid 64 be provided with a higher voltage for long-haul distribution using smaller gauge wires and, periodic voltage reducing transformers are placed along the grid to provide a lower voltage to one or more sections 51 of the road-based conductors 50/52.

Also, in some embodiments, the vehicle detection sensor 54 also senses an identification of the vehicle 100 by, for example, an RFID associated with the vehicle 100 and sensed by the vehicle detection sensor 54, by a radio frequency signal emitted by the vehicle 100 and received/detected by the vehicle detection sensor 54, by camera and image recognition, or any way known. In some embodiments, the vehicle detection sensor 54 is the same as used for quick pass access to toll roads. In any case, in such embodiments, having an identification of the vehicle 100, the system for powering vehicles has the ability to know which vehicle 100 is accepting power and, therefore, has the ability to charge each vehicle 100 for an amount of power used by the vehicle 100. Further, in some embodiments, while the vehicle 100 is detected and recognized (e.g. the system for powering vehicles has an identification of the vehicle 100), a circuit in the power switching device 72 measures the amount of power used by the vehicle 100 for billing of the amount of power used, as once the batteries 112 (see FIGS. 8 and 9) of the vehicle 100 are charged, less power is required from the system for powering vehicles.

For control of the system for powering vehicles and for receiving data from each section 51 of the road-based conductors 50/52, in some embodiments a data bus 80 is connected to the switch control logic 70 through data connections 82. The data bus 80 is anticipated to be any networking media such as Ethernet. In some embodiments, the data is modulated over the power grid 64 instead of requiring the data bus. In some embodiments, each time a vehicle 100 is detected, then moves off of the section 51, a data record containing the vehicle identification and an amount of usage (either calculated based upon power usage or estimated based upon an amount of time that the vehicle 100 is on the section 51) is transmitted to a central location (e.g. over the data bus) for later billing.

In some embodiments, identities of vehicles 100 with outstanding debts are included in a blacklist that is distributed to the switch control logic 70, for example, through data connections 82. In such embodiments, if an owner of the vehicle 100 has not paid a bill for a certain amount of time, the identification to the vehicle 100 is included in the blacklist and, when the vehicle 100 is detected, if the identification of the vehicle 100 matches an entry in the blacklist, the switch control logic 70 does not enable the power switching device 72 and, therefore, no power is provided to the vehicle 100.

In FIG. 6, an opposite side view of the powered roadway 48 is shown. In this, the far road-based conductor 50 is shown slightly raised above the powered roadway 48. The far road-based conductor 50, in this embodiment, is connected to a ground, second pole, or neutral leg 65 of the power grid by a ground conductor 67.

Referring to FIG. 7, a schematic view of a powered roadway 48 of the system for powering vehicles is shown. The near road-based conductor 52 selectively receives power through conductors 66 that connect the near road-based conductor 52 to a power switching device 72 such as a relay or solid-state switch. Power for the powered roadway 48 is provided from a power grid 64 that is connected to the power switching device 72. The power switching device 72 is controlled by switch control logic 70 which, in some embodiments, is processor-based (e.g. micro-controller). The switch control logic 70 reads the vehicle detection sensor 54 through a cable 68 to determine if a vehicle 100 is present above the associated section 51 of road-based conductors 50/52. If the switch control logic 70 determines a vehicle 100 is present, the switch control logic 70 enables the power switching device 72 so that electrical power is provided to the near road-based conductor 52. In some embodiments, the switch control logic 70 includes a current limiting feature that prevents excess current flow through the road-based conductors 50/52 should a short circuit occur (e.g. a short from a snow plow blade).

Power is provided to the power switching device 72 by another conductor 62 that connects the power switching device 72 to the power grid 64. As discussed above, in some embodiments, the voltage potential delivered to the near road-based conductor 52 is set to a voltage deemed save for most form of life, for example, 48 volts, though there is no limitation on any particular voltage, either direct current or alternating current. In some embodiments, the power grid 64 is provided with a higher voltage suitable for long-haul distribution using smaller gauge wires and, voltage reducing transformers are placed along the grid to provide a lower voltage to one or more sections 51 of the road-based conductors 50/52.

Also, in some embodiments, the vehicle detection sensor 54 also senses an identity of the vehicle 100 by, for example, an RFID associated with the vehicle 100 is sensed by the vehicle detection sensor 54, a radio frequency signal emitted by the vehicle 100 and received/detected by the vehicle detection sensor 54, a camera and image recognition detects the vehicle 100, or any way known. In some embodiments, the vehicle detection sensor 54 is the same as used for quick pass access to toll roads. In any case, in such embodiments, having an identification of the vehicle 100, the system for powering vehicles has the ability to know which vehicle 100 is accepting power and, therefore, has the ability to charge money for that vehicle 100 based upon an amount of power used by the vehicle 100. Further, in some embodiments, while the vehicle 100 is detected and recognized (e.g. the system for powering vehicles has an identification of the vehicle 100), a circuit in the power switching device 72 measures the amount of electrical power delivered to the vehicle 100 for billing of the amount of electrical power used, as once the batteries 112 (see FIGS. 8 and 9) of the vehicle 100 are charged, less power is required from the system for powering vehicles.

For control of the system for powering vehicles and for receiving data from each section 51 of the road-based conductors 50/52, in some embodiments a data bus 80 is connected to the switch control logic 70 through data connections 82. The data bus 80 is anticipated to be any networking media such as Ethernet. In some embodiments, the data is modulated over the power grid 64 instead of requiring a separate data bus 80. In some embodiments, each time a vehicle 100 is detected on a section 51, then moves off of the section 51, a data record containing the vehicle identification and an amount of electrical power usage (either calculated based upon power usage or estimated based upon an amount of time that the vehicle 100 is on the section 51) is transmitted to a central location (e.g. over the data bus) for later billing.

In some embodiments, identities of vehicles 100 with outstanding debts are included in a blacklist that is distributed to the switch control logic 70 (typically processor-based with storage), for example, through data connections 82. In such embodiments, if an owner of the vehicle 100 has not paid a bill for a certain amount of time, the identification to the vehicle 100 is included in the blacklist and, when the vehicle 100 is detected, if the identification of the vehicle 100 matches an entry in the blacklist, the switch control logic 70 does not enable the power switching device 72 and, therefore, no electric power is provided to the vehicle 100.

Referring to FIGS. 8 and 9, schematic views of a vehicle 100 utilizing the system for powering vehicles are shown. In FIG. 8, the vehicle 100 has four of the tires 10 with conductive surfaces 12. Ground potential from the far road-based conductor 50 is received by a first pair of the tires 10 and delivered to the first section 34 of the axle where first pickups 40 connect the charge circuit 110 of the vehicle 100 to ground potential. Electrical power from the near road-based conductor 52 is received by a second pair of the tires 10 and delivered to the second section 38 of the axle where second pickups 41 deliver the electrical power to the charge circuit 110 of the vehicle 100. The charge circuit 110 provides charge current to the batteries 112 of the vehicle 100 (and, in some embodiments, operational power to electric motors of the vehicle 100 that are not shown for clarity reasons). As with existing vehicles 100 that operate on electrical power, a charge port 114 is provided for charging the vehicle 100 from a charging station.

In FIG. 9, the vehicle 100 has two tires 10 with conductive surfaces 12 and two tires 11 that do not conduct. Ground potential from the far road-based conductor 50 is received by a first the tires 10 with conductive surfaces 12 and is connected to a solid axle 35 where first pickups 40 connect the charge circuit 110 of the vehicle 100 to ground potential. Electrical power from the near road-based conductor 52 is received by a second of the tires 10 with conductive surfaces 12 and delivered to a different solid axle 35 where second pickups 41 deliver the electrical power to the charge circuit 110 of the vehicle 100. As above, the charge circuit 110 provides charge current to the batteries 112 of the vehicle 100 (and, in some embodiments, operational power to electric motors of the vehicle 100 that are not shown for clarity reasons). As with existing vehicles 100 that operate on electrical power, a charge port 114 is provided for charging the vehicle 100 from a charging station.

In both FIGS. 8 and 9, an optional identification device 120 is shown. In some embodiments, the optional identification device 120 is detected by the vehicle detection sensor 54 to sense presence of a vehicle 100 that is authorized to receive power from the powered roadway 48. In some embodiments, the optional identification device 120 includes an identification code that uniquely identifies the vehicle 100 for purposes of enabling electrical power to only those vehicles 100 that are registered, are in good standing, etc.

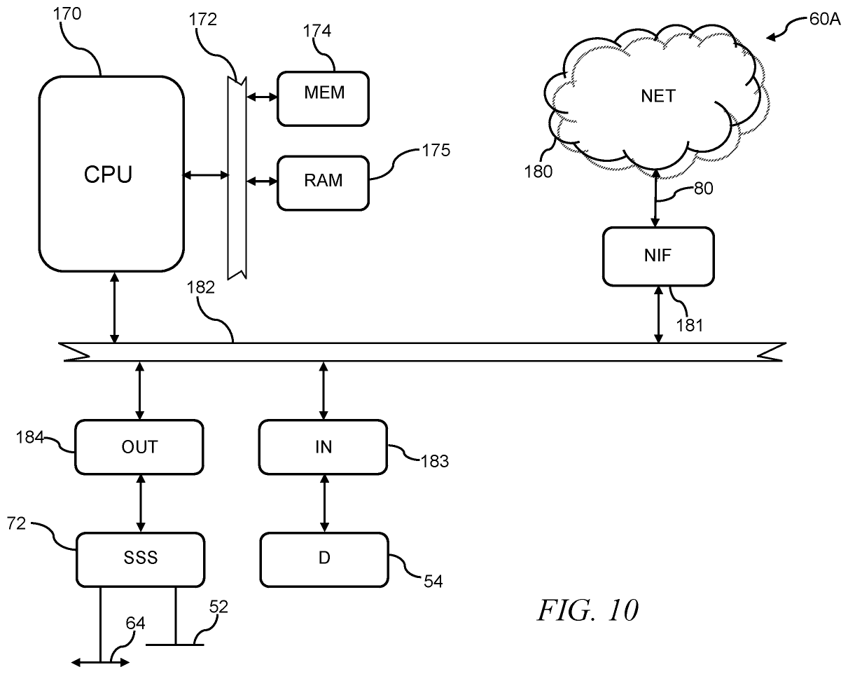

Referring to FIG. 10, a schematic view of a processor based circuit 60A is shown. The exemplary processor based circuit 60A provides control to a section 51 of road-based conductors 50/52. The present invention is in no way limited to any particular configuration.

The exemplary processor based circuit 60A is shown in its simplest form. Different architectures are known that accomplish similar results in a similar fashion, and the present invention is not limited in any way to any particular system architecture or implementation. In this exemplary processor based circuit 60A, a processor 170 executes or runs programs in a random access memory 175. The programs are generally stored within a persistent memory 174 and loaded into the random access memory 175 when needed. The processor 170 is any processor, typically a processor designed for phones. The persistent memory 174 and random access memory 175 are connected to the processor by, for example, a memory bus 172. The random access memory 175 is any memory suitable for connection and operation with the selected processor 170, such as SRAM, DRAM, SDRAM, RDRAM, DDR, DDR-2, etc. The persistent memory 174 is any type, configuration, capacity of memory suitable for persistently storing data, for example, flash memory, read only memory, battery-backed memory, etc. In some embodiments, the blacklist is stored in the persistent memory 174.

Also connected to the processor 170 is a system bus 182 for connecting to peripheral subsystems such as a network interface 181, an output port 184 for driving the power switching device 72, and an input port 183 for reading the vehicle detection sensor 54, though there is no restriction on inputs and outputs.

In general, some portion of the persistent memory 174 is used to store programs, executable code, and data, etc.

The network interface 181 connects the exemplary processor based circuit 60A to the network 180 through a data bus 80. There is no limitation on the type of connection used. The network interface 181 provides data and messaging connections between exemplary processor based circuit 60A and a server (not shown for clarity reasons) through the network 180.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for powering vehicles, the system comprising:
a powered roadway comprising of a plurality of pairs of road-based conductors, each pair of road-based conductors being parallel, a voltage is delivered across each of the pair of road-based conductors;
a first tire of the vehicle having a first conductive surface and a second tire of the vehicle having a second conductive surface, the first conductive surface is in electrical contact with a first road-based conductor of one pair of road-based conductors and the second conductive surface is in electrical contact with a second road-based conductor of the one pair of road-based conductors, thereby the voltage across the one pair of road-based conductors is conducted into the vehicle through the first conductive surface and the second conductive surface; and
a vehicle power system receives the voltage from the first conductive surface and the second conductive surface and provides power to the vehicle.

2. The system of claim 1, wherein the vehicle power system receives the voltage from the first conductive surface and the second conductive surface and provides the power to an electric motor of the vehicle for moving the vehicle.

3. The system of claim 1, wherein the vehicle power system receives the voltage from the first conductive surface and the second conductive surface and provides the power to charge at least one battery of the vehicle.

4. The system of claim 1, wherein the powered roadway further comprises a vehicle detection sensor interfaced to the powered roadway at the one pair of the road-based conductors.

5. The system of claim 4, wherein the voltage is delivered across the one pair of road-based conductors only when the vehicle is detected by the vehicle detection sensor that is interfaced to the powered roadway at the one pair of road-based conductors.

6. The system of claim 4, wherein the vehicle detection sensor detects a mass of the vehicle.

7. The system of claim 4, wherein the vehicle detection sensor detects a change in resonance as caused by metal of the vehicle.

8. The system of claim 4, wherein the vehicle detection sensor further detects an identity of the vehicle.

9. The system of claim 8, wherein the identity of the vehicle is used to generate billing for usage of the voltage.

10. A method of powering vehicles comprising:
delivering a voltage across two road-based conductors;
receiving one pole of the voltage by a first conductive surface of a first tire of the vehicle, the first conductive surface being in electrical contact with a first road-based conductor of the two road-based conductors;
receiving a second pole of the voltage by a second conductive surface of a second tire of the vehicle, the second conductive surface being in electrical contact with a second road-based conductor of the two road-based conductors; and
conducting the voltage from the first conductive surface and the second conductive surface into a charge circuit of the vehicle, thereby providing power to the vehicle for charging and/or for motivating the vehicle.

11. The method of claim 10, further comprising:
detecting of the vehicle when the vehicle is over the two road-based conductors.

12. The method of claim 11, wherein the step of delivering the voltage across two road-based conductors is only performed while detecting the vehicle.

13. The method of claim 11, wherein the detecting of the vehicle comprises detecting a mass of the vehicle.

14. The method of claim 11, wherein the detecting of the vehicle comprises detecting an electromagnetic resonance of the vehicle.

15. The method of claim 11, wherein the detecting further comprises detecting an identification of the vehicle.

16. The method of claim 11, further comprising billing based upon the identification of the vehicle.

17. A system for powering vehicles, the system comprising:
a powered roadway comprising of a pair of road-based conductors that are parallel, a source of electricity and a controller, the controller selectively connects the source of the electricity to the pair of road-based conductors;
a first tire of the vehicle comprising a first conductive surface and a second tire of the vehicle comprising a second conductive surface; the first conductive surface is in electrical contact with a first road-based conductor of the pair of road-based conductors and the second conductive surface is in electrical contact with a second road-based conductor of the pair of road-based conductors, thereby the voltage across the one pair of road-based conductors is conducted into the vehicle through the first conductive surface of the first tire and the second conductive surface of the second tire; and
a vehicle power system is electrically interfaced to the first conductive surface and to the second conductive surface;
a vehicle detection sensor is operatively interfaced to the controller such that upon detection of the vehicle by the vehicle detection sensor, the controller connects the source of the electricity to the pair of road-based conductors, thereby providing the electricity to the vehicle and when the vehicle detection sensor signals an absence of the vehicle, the controller disconnects the source of the electricity from the pair of road-based conductors.

18. The system of claim 17, wherein the vehicle detection sensor detects either a mass of the vehicle or a change in resonance as caused by metal of the vehicle.

19. The system of claim 17, wherein the vehicle detection sensor further detects an identity of the vehicle.

20. The system of claim 19, wherein the identity of the vehicle is used to generate billing for usage of the voltage.
